(19) United States
(12) Patent Application Publication
(10) Pub. No.: US 2024/0426344 A1
(43) Pub. Date: Dec. 26, 2024

(54) PINION BEARING UNIT

(71) Applicant: Aktiebolaget SKF, Göteborg (SE)

(72) Inventors: Pasquale FREZZA, Aversa (CE) (IT); Andrea A. BERTOLINI, Carrara (IT); Fausto BARACCA, Massa (IT); Renato BERTI, Massa (IT)

(21) Appl. No.: 18/746,150

(22) Filed: Jun. 18, 2024

(30) Foreign Application Priority Data
Jun. 26, 2023 (IT) 102023000013110

(51) Int. Cl. F16C 35/06; F16C 19/06; F16H 55/17

(52) U.S. Cl. CPC F16C 35/06; F16C 19/06; F16H 55/17; F16C 2361/61

(57) ABSTRACT

A pinion bearing unit (10) has a pinion (20) with a cylindrical and radially internal seat (21), and a bearing unit (30) housed inside the seat (21). The pinion (20) has at least one pair of fins (40, 40′). Each of the fins being arranged on a respective outer annular wall (22, 22′) of the pinion (20) and extending axially on opposite sides of the seat (21) in order to be deflected by 90°, abutting the bearing unit (30), such that the bearing unit (30) is locked axially inside the seat (21).

### CROSS-REFERENCE TO RELATED APPLICATION

This application claims priority to Italian Application No. 102023000013110, filed Jun. 26, 2023, the entirety of which is hereby incorporated by reference.

### FIELD

The present disclosure relates to a pinion bearing unit which is preferably, but not exclusively, used in units for transmitting the motion of industrial machinery, to which the description below will make specific reference without thereby losing its general character.

### BACKGROUND

In industrial machinery, the pinion bearing units of the known type are mainly used as chain tensioner in motion transmitting units, and comprise:
a pinion provided with a radially internal cylindrical seat, and
a bearing unit housed in the cylindrical seat.

The bearing unit typically comprises a radially inner ring, usually mounted on a central axis of the motion transmitting unit, and a radially outer ring, rigidly connected to the pinion. The relative rotation of the outer ring with respect to the inner ring is ensured by a plurality of rolling bodies, typically balls. The balls are designed to roll inside a radially outer raceway formed on the inner ring and a corresponding radially inner raceway formed on the outer ring.

Due to the stresses that occur during the operation of the unit and, in particular, due to the vibrational motion induced on the pinion by the motion transmitting unit, undesired demounting of the pinion bearing unit can occur.

Usually, in this type of applications, the loads are predominantly radial since the pinion is used to tension a motion transmitting chain. However, the vibrations induced by the motion transmitting unit can also determine axial loads on the unit. The chain is locked between several gears, and thus it is difficult for it to be demounted by such axial loads. By contrast, the prolonged effect of the vibrations over time can lead to demounting of the pinion with respect to the bearing unit: the bearing unit is locked on the central axis, but the pinion may move axially and be demounted from the bearing unit, thus falling down.

To overcome this drawback, two solutions aimed at mutually securing the bearing unit and the pinion are known:
a first solution provides for the bearing unit to be mounted with interference inside the seat of the pinion. However, this solution entails the risk that high interference values between the bearing unit and the pinion can cause the inner geometry of the bearing unit to deform. Conversely, this solution is not very effective when low interference values are used, allowing undesired demounting of the pinion bearing unit to still occur,
a second solution provides for the use of a retaining ring, for example a Seeger ring, which can ensure the mutual axial locking between the outer ring of the bearing unit and the pinion. However, this second solution also has some drawbacks:
firstly, it is necessary to design an axially longer pinion in order for there to be enough space for insertion of the retaining ring;
it is necessary to use an additional component;
the presence of a further component moreover entails longer mounting and demounting times.

### SUMMARY

The present disclosure is therefore intended to provide a pinion bearing unit that does not have the drawbacks described above.

Therefore, the present disclosure provides a pinion bearing unit having the features set out in the independent claim attached to the present description.

Further embodiments of the present disclosure, which are preferred and/or particularly advantageous, are described according to the features set out in the attached dependent claims.

### BRIEF DESCRIPTION OF THE DRAWINGS

The present disclosure will now be described with reference to the attached drawings, which show a non-limiting example embodiment thereof, in which:

FIG. 1 shows a cross section of a pinion bearing unit in a preferred embodiment of the present disclosure and according to an intermediate mounting configuration,

FIG. 2 shows an axonometric view of the unit in FIG. 1,

FIG. 3 shows, in section and on an enlarged scale, a detail of the unit in FIG. 1, and

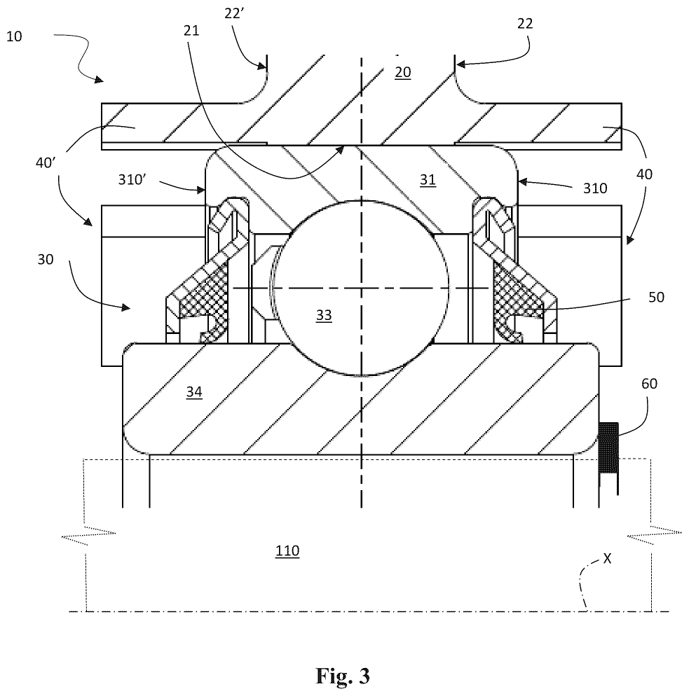

FIG. 4 shows, in cross section and with parts removed for clarity, the unit in FIG. 1 in a final mounting configuration.

### DETAILED DESCRIPTION

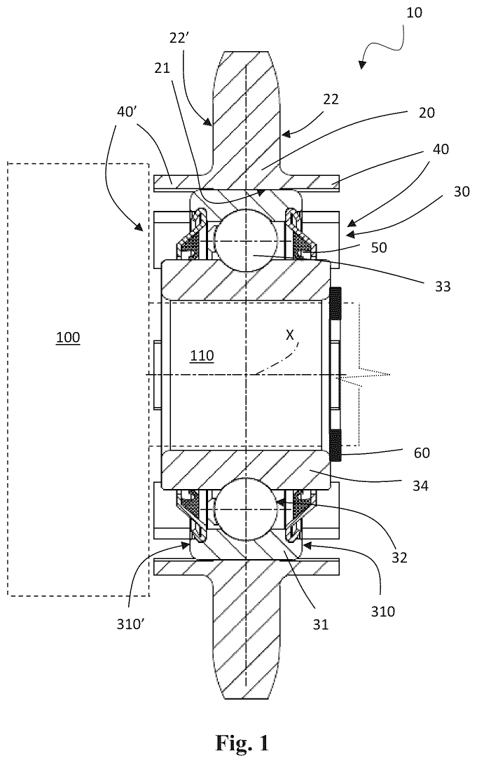

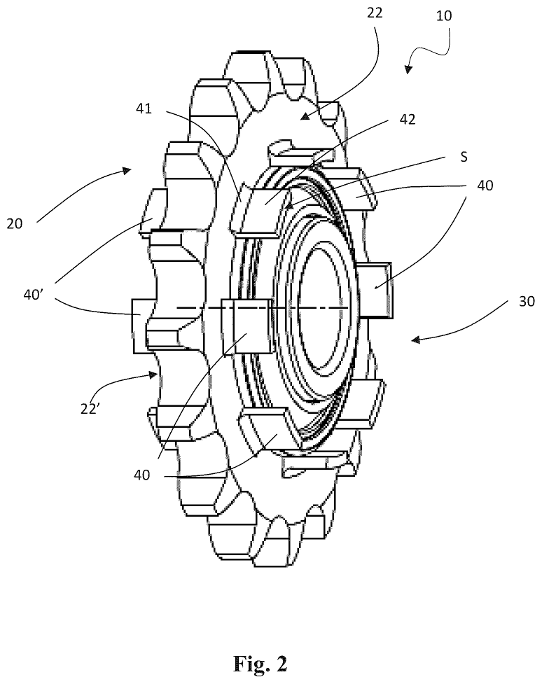

With reference to FIGS. 1 and 2, 10 shows overall a pinion bearing unit 10 applied to a motion transmitting unit 100 of the known type and shown purely schematically.

The pinion bearing unit 10 has a central axis of rotation X, and comprises:
a bearing unit 30; and
a pinion 20, provided with a radially internal cylindrical seat 21 for housing the bearing unit 30, and with at least one pair of fins 40 and 40′ arranged on respective lateral annular walls 22 and 22′ of the pinion 20.

A first fin 40 of the pair of fins 40, 40′ extends axially towards the outside, namely away from the motion transmitting unit 100, and a second fin 40′ of the pair of fins 40, 40′ extends axially towards the inside, namely towards the motion transmitting unit 100. The geometry and the function of the fins 40, 40′ will be described in more detail below.

The bearing unit 30 comprises, for its part:
a radially outer ring 31, rigidly connected to the pinion 20,
a radially inner ring 34, rigidly connected to a shaft 110 (of the known type and thus only shown schematically) of the motion transmitting unit 100,
a row 32 of rolling bodies 33, in this case balls, interposed between the radially outer ring 31 and the radially inner ring 34, and
at least one sealing device 50 arranged between the radially inner ring 34 and the radially outer ring 31 in order to protect the bearing unit 30 from external contaminants.

Throughout the present description and in the claims, terms and expressions indicating positions and orientations, such as “radial” and “axial”, are to be understood with reference to the central axis of rotation X of the bearing unit 30. Furthermore, the term “axially internal” should be understood as the axial direction towards the body of the machine to which the pinion bearing unit 10 is applied. The opposite direction will obviously be indicated by the term “axially external”.

According to one design, the pinion 20 is produced in such a way as to be able to solve the problem of the undesired demounting from the bearing unit 30, namely to prevent the axial movement of the pinion with respect to the bearing unit 30.

The main objective of the solution is:
to improve the mounting of the pinion bearing unit, reducing the coupling with interference between the radially outer ring of the bearing unit, and
to axially lock the bearing unit around the entire circumference.

This is achieved by means of the fins 40, 40′ with which the pinion 20 is provided.

Each fin 40, 40′ comprises:
a prismatic base 41 securely fastened to the annular wall 22, 22′ of the pinion, and
a tooth 42, orthogonal to the prismatic base 41, from which it protrudes axially.

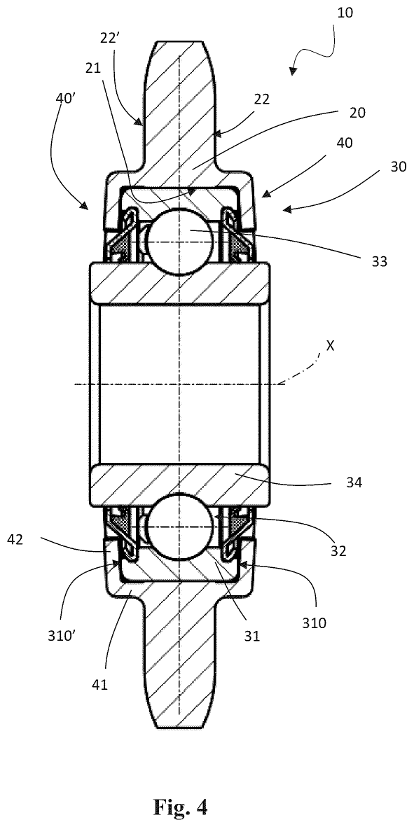

With reference also to FIG. 4, once the bearing unit 30 is mounted inside the seat 21 of the pinion, the teeth 42 of the fins 40, 40′ are deflected, namely folded through about 90°, so as to abut the bearing unit 30. In particular, the abutting is effected using, as abutment elements, the outer annular edges 310, 310′ of the radially outer ring 31. Therefore, the teeth 42 of the fins 40, 40′ pass from a configuration with an axial extent, prior to the mounting of the bearing unit, to a configuration with a substantially radial extent, after the mounting of the bearing unit 30 in the seat 21 of the pinion 20.

In this way, the fins 40, 40′ folded to 90°, engaging with the respective annular edges 310, 310′ of the radially outer ring 31, axially lock the entire bearing unit 30 inside the seat 21 of the pinion 20.

Advantageously, the teeth 42 of the fins 40, 40′ have a cross section S having a thickness ranging between 1.5 mm and 2.0 mm. The cross section with a thin thickness allows the teeth 42 of the fins 40, 40′ to be folded very easily, using hammers or compression tools. Values lower than 1.5 mm could cause the tooth of the fin to break, whereas values greater than 2.0 mm would make folding of said tooth difficult.

Advantageously, in order to be able to ensure axial locking of the bearing unit, around the entire circumference of the annular edges 310, 310′, there may be more than one fin 40, 40′ for each annular wall 22, 22′ of the pinion 20. A possible solution, inferred by calculations and experimental tests, provides for eight respective fins 40, 40′ to be arranged circumferentially equidistantly from each other on each annular wall 22, 22′. This number of fins represents an optimal solution for two conflicting requirements: ensuring solid retention of the bearing unit, and not complexifying the procedure of folding the fins.

Advantageously, it is expedient to provide a slight interference between the seat 21 of the pinion 20 and the radially outer cylindrical surface 31′ of the radially outer ring 31 of the bearing unit. The interference value to be adopted may nevertheless be lower than the interference value required according to the prior art for mutually securing the bearing unit and the pinion in the absence of a mechanical stop (the shoulder): indeed, whilst it is necessary to use the M7 tolerance class according to the prior art, according to the present disclosure it will be enough to adopt the N7 tolerance class which provides lower interference values than the preceding class. Considering, for a typical application, a bearing unit outer diameter of 40 mm, there is thus a change from an interference of between 0.08 mm and 0.33 mm (M7 tolerance class) to an interference of between 0 and 0.25 mm (N7 tolerance class). Using smaller interference values avoids any risk of deformation of the inner geometry of the bearing and also allows the radially outer ring to be correctly mounted near the shoulder 40 against the annular surface 42 thereof.

Advantageously, in order to avoid axial movements of the pinion bearing unit 10 overall, the bearing unit 30 may be axially locked so as to secure the radially inner ring 34 to the shaft 110 of the motion transmitting unit 100 by means of a retaining ring 60, for example a Seeger ring, or a locking pin.

In summary, the procedure of mounting the bearing unit 30 inside the seat 21 of the pinion 20 is very simple and comprises the following two steps:
inserting the bearing unit 30 inside the seat 21 of the pinion, possibly effecting coupling between the seat 21 and the radially outer ring 31 with a slight interference according to the N7 tolerance class, and
folding, by means of hammers or compression tools, the teeth 42 of the fins 40, 40′ substantially to 90°, such that they are stopped at respective abutments formed by the annular edges 310, 310′ of the radially outer ring 31 of the bearing unit 30.

From the point of view of the production process, the solution according to the present disclosure is thus simpler than the known implementations. Indeed, operating according to the prior art, producing the seat of the bearing unit in the pinion, both using a notable interference between the pinion and the outer ring and using a Seeger ring, still requires the performance of precision mechanical machining. However, the present solution merely requires a simpler operation of folding the fins, in order to ensure the axial locking of the bearing unit.

In summary, according to the present disclosure the solution concerning the pinion bearing unit achieves the predefined objects since it makes it possible to not have mutual axial movements between the bearing unit and the pinion and therefore to avoid accidental demounting.

In addition to the embodiment of the present disclosure as described above, it should be understood that there are numerous other variants. It should also be understood that these embodiments are solely exemplary and do not limit the scope of the present disclosure, its applications, or its possible configurations. On the contrary, although the above description enables those skilled in the art to implement the present disclosure according to at least one exemplary embodiment thereof, it should be understood that numerous variations of the described components are possible, without thereby departing from the scope of the present disclosure as defined in the appended claims, interpreted literally and/or according to their legal equivalents.

What is claimed is:

1. A pinion bearing unit comprising:
a pinion having a cylindrical and radially internal seat and at least one pair of fins, the fins being arrange on respective axially outer annular walls of the pinion, the fins extending axially on opposite sides of the seat, and
a bearing unit housed inside the seat, the bearing unit having a radially outer ring connected to the pinion and a radially inner ring,
wherein the fins are configured to be deflected, during an assembly of the unit, to abutting the bearing unit so that the bearing unit is locked axially inside the seat.

2. The unit according to claim 1, wherein the fins of the at least one pair of fins abut against outer annular edges of the radially outer ring of the bearing unit.

3. The unit according to claim 1, wherein each fin comprises:
a prismatic base solidly fixed to the annular wall of the pinion, and
a tooth, orthogonal to the prismatic base, from which the tooth protrudes axially.

4. The unit according to claim 3, wherein the teeth of the fins have a cross section having a thickness ranging between 1.5 mm and 2.0 mm.

5. The unit according to claim 1, wherein there are eight fins for each annular wall of the pinion.

6. The unit according to claim 1, wherein between the seat of the pinion and a cylindrical surface, radially external, of the radially outer ring there is an interference comprised in the tolerance class N7.

7. The unit according to claim 6, wherein the interference is between 0 mm and 0.25 mm.

8. The unit according to claim 2, wherein each fin comprises:
a prismatic base solidly fixed to the annular wall of the pinion, and
a tooth, orthogonal to the prismatic base, from which the tooth protrudes axially.

9. The unit according to claim 8, wherein the teeth of the fins have a cross section having a thickness ranging between 1.5 mm and 2.0 mm.

10. The unit according to claim 9, wherein there are eight fins for each annular wall of the pinion.

11. The unit according to claim 10, wherein between the seat of the pinion and a cylindrical surface, radially external, of the radially outer ring there is an interference comprised in the tolerance class N7.

12. The unit according to claim 11, wherein the interference is between 0 mm and 0.25 mm.

13. An assembly method of a pinion bearing unit comprising:
inserting a bearing unit inside a cylindrical and radially internal seat of a pinion such that a radially outer ring of the bearing unit is rigidly connected to the pinion, the pinion having at least one pair of fins, each of the fins arranged on a respective outer annular wall of the pinion, and
deflecting teeth of the fins substantially at 90°, stopping them at respective abutments made by annular edges of the radially outer ring of the bearing unit.

14. The method according to claim 13, wherein said inserting the bearing unit is performed by carrying out the coupling between the seat and the radially outer ring with an interference according to the tolerance class N7.

15. The method according to claim 13, wherein said deflecting the teeth is carried out by means of hammers or compression tools.

16. The method according to claim 14, wherein said deflecting the teeth is carried out by means of hammers or compression tools.
